(19) United States
(12) Patent Application Publication
(10) Pub. No.: US 2025/0358629 A1
(43) Pub. Date: Nov. 20, 2025

(54) RFID Range Extension via Adjacent Bandwidth

(71) Applicant: T-Mobile Innovations LLC, Overland Park, KS (US)

(72) Inventors: Lyle T. BERTZ, Lee’s Summit, MO (US); Pei HOU, Centreville, VA (US); Harry William PERLOW, Palm Harbor, FL (US); Durga Prasad SATAPATHY, Ashburn, VA (US)

(21) Appl. No.: 18/665,407

(22) Filed: May 15, 2024

(51) Int. Cl. H04W 16/14; G06Q 10/083

(52) U.S. Cl. CPC H04W 16/14; G06Q 10/083

(57) ABSTRACT

A communication system for inventory management via wireless monitoring comprises radio frequency identification (RFID) tags configured to operate in a frequency band that is unlicensed in a first geographic region and is licensed in a second geographic region. The communication system also comprises a RFID reader designed according to operational parameters of the first geographic region. The RFID reader is configured to read, in the second geographic region, data from the RFID tags via radio frequency (RF) signal transmissions in the frequency band at a power level that exceeds the operational parameters of the first geographic region. The RFID reader comprises a RF circuit, an antenna, and a controller. The controller is configured to program the RF circuit with second operational parameters, which cause the RFID reader to operate outside of requirements for operation in the unlicensed frequency spectrum in the first geographic region as defined by the operational parameters.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Some wireless identification (ID) tags respond to a radio frequency (RF) signal from a reader device by emitting an RF response signal. Some wireless identification tags emit an RF response signal in response to a signal comprising predetermined data, while other wireless identification tags emit an RF response signal in response to detecting RF radiation in a predetermined RF frequency band. Some such wireless identification tags are referred to as RFID tags.

### SUMMARY

In an embodiment, a communication system for inventory management via wireless monitoring is disclosed. The communication system comprises radio frequency identification (RFID) tags configured to operate in a frequency band that is unlicensed in a first geographic region and is licensed in a second geographic region. The communication system also comprises a RFID reader designed according to operational parameters of the first geographic region. The RFID reader is configured to read, in the second geographic region, data from the RFID tags via radio frequency (RF) signal transmissions in the frequency band. The RFID reader performs the RF signal transmissions at a power level that exceeds the operational parameters of the first geographic region. The RFID reader comprises a RF circuit. The RF circuit is programmed according to the operational parameters. The RFID reader also comprises an antenna communicatively coupled to the RF circuit and configured to perform the RF signal transmissions in the frequency band. The RFID reader further comprises a controller coupled to the RF circuit. The controller is configured to program the RF circuit with second operational parameters. The second operational parameters are configured to cause the RFID reader to operate outside of requirements for operation in the unlicensed frequency spectrum in the first geographic region as defined by the operational parameters.

In another embodiment, an apparatus configured at a first time with first system parameters according to requirements for operation in unlicensed frequency spectrum in a first geographic region is disclosed. The apparatus comprises a radio frequency (RF) circuit. The RF circuit is programmed according to the first system parameters. The apparatus also comprises an antenna communicatively coupled to the RF circuit and configured to perform RF transmissions in a band of licensed frequency spectrum in a second geographic region different from the first geographic region. The band of licensed frequency spectrum is overlapping with the unlicensed frequency spectrum. The apparatus further comprises a controller coupled to the RF circuit. The controller is configured to program the RF circuit with second system parameters. The second system parameters configured to cause the apparatus to operate outside of the requirements for operation in the unlicensed frequency spectrum in the first geographic region.

In yet another embodiment, an apparatus having system parameters configured according to requirements for operation in unlicensed frequency spectrum in a first geographic region is disclosed. The apparatus comprises a controller, a radio frequency (RF) circuit communicatively coupled to the controller, and an antenna communicatively coupled to the RF circuit and configured to perform RF transmissions in a band of licensed frequency spectrum in a second geographic region different from the first geographic region. The band of licensed frequency spectrum is overlapping with the unlicensed frequency spectrum. The antenna has a gain that exceeds a gain limit of the requirements for operation in the unlicensed frequency spectrum in the first geographic region.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system, in accordance with various examples.

FIG. 2 is a block diagram of a reader, in accordance with various examples.

FIG. 3 is a flowchart of a method, in accordance with various examples.

FIG. 4 is a block diagram of a hardware architecture of a device, in accordance with various examples.

### DETAILED DESCRIPTION

It should be understood at the outset that although illustrative implementations of one or more examples are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

An RFID tag may emit an RF response signal in response to an interrogation signal or in response to receiving RF radiation. An RFID tag response typically includes a small amount of preprogrammed or programmable fixed data, such as a tag ID value. In some systems, a conventional RFID reader device (or “reader”) might be used to read the fixed data from an RFID tag. The RFID tag and the RFID reader may communicate via an industrial, scientific, and medical (ISM) frequency spectrum (e.g., ISM band) which varies from licensed telecommunications spectrum. Because of the unlicensed nature of the ISM band, restrictions may be placed on usage of the ISM band, such as by governmental regulations, accepted industry standards or practices, or the like. These restrictions may include a restriction on transmission power, such as to prevent interference between the unlicensed ISM band and other licensed spectrum. However, this restricted transmission power may reduce a user experience in using devices communicating in the ISM band, such as by reducing a range at which the devices may successfully communicate, or the like.

An RFID reader may have a technical capability to communicate, or listen, to the full ISM spectrum, which may be about 860-960 megahertz (MHz). However, the RFID reader may be tuned or optimized for a geographic region in which it operates. For example, a first RFID reader may be tuned or optimized to operate in a frequency spectrum of approximately 902-928 MHz for operation in the United States. A second RFID reader may be tuned or optimized to operate around a frequency spectrum of approximately 860 MHz for operation in Europe. However, a portion of the ISM band that is unlicensed in one region (such as 860 MHz in Europe) may be encompassed in licensed spectrum in another region (such as the United States). Because the ISM band is unlicensed in its respective geographic region, as described above, a transmission power of devices operating in the ISM band may be limited. For example, government regulations, industry standards, or the like may limit the transmission power in the ISM band to approximately 36 decibel (dB) milliwatts (dBm). Similar transmission power restrictions may not be imposed on licensed spectrum, or transmission power restrictions imposed on licensed spectrum may allow for greater transmission power than in the ISM band.

In some examples, communication range of RFID devices (e.g., a RFID reader reading a RFID tag) doubles for every 6 dB increase in transmission power of the reader. More generally, communication range of RFID devices increases as transmission power of the reader increases. Thus, by increasing the transmission power of an RFID reader beyond the transmission power permitted in the ISM band, a distance at which the RFID reader could read RFID tags may be increased.

As described above, the unlicensed ISM band in a first geographic region may overlap with licensed spectrum in a second geographic region. As a result, by implementing an RFID reader that is optimized for operation in the first geographic region (such as Europe) instead in the second geographic region (such as the United States), communication range of the RFID reader and RFID tags in the second geographic range may be increased. For example, because the RFID reader optimized for operation in the first geographic region is optimized for operation at a frequency, or within a frequency range, that overlaps with licensed spectrum in the second geographic region, the RFID reader may be implemented in the second geographic region with a transmission power that is greater than allowed in the ISM band. This increased transmission power increases the RFID communication range, as described above.

In addition, such an implementation may be a low-cost, low-complexity implementation that has a comparatively fast implementation time. For example, by using an already designed RFID reader optimized for the first geographic region and coupling the RFID reader with a high gain antenna (e.g., having a transmission power greater than allowed in the ISM band), the RFID communication range may be increased. Such an approach may eliminate or reduce at least some of the development time, development cost, or other complexities associated with redesigning RFID tags and/or RFID readers to extend RFID communication range. In some examples, the RFID reader may be configured through firmware, software, or both to optimize its performance with the high gain antenna. For example, the RFID reader may be configured to limit the RFID reader in a manner contrary to industry norms, such as to prevent frequency hopping, limit on which frequency bands the RFID reader may communicate, or the like.

While described herein as the licensed and unlicensed spectrum overlapping, in some examples, no overlap in frequencies exists. Rather, the licensed spectrum may be adjacent to the unlicensed spectrum. However, RFID tags may be comparatively inexpensive device that utilize lower cost, and therefore lower precision, components than other devices. As a result, the RFID tags may leak, or have an ability to communicate outside of the frequency band or spectrum for which they are designed. For example, an RFID tag designed for operation in the ISM band of 860-960 MHz may still be able to communicate with an RFID reader that transmits in an 850 MHz band. As such, though no overlap in licensed and unlicensed spectrum exists, a functional overlap exists such that functionally of the RFID reader may be similar to the operation described herein for examples in which the licensed and unlicensed spectrums overlap. For example, the RFID reader may transmit in the licensed spectrum adjacent to an unlicensed spectrum for which an RFID tag exists, and may still receive a data response from the RFID tag because the frequency range in which the RFID tag is operable may leak, drift, or otherwise vary from strict adherence to the ISM band, or another frequency range for which the RFID tag is designed.

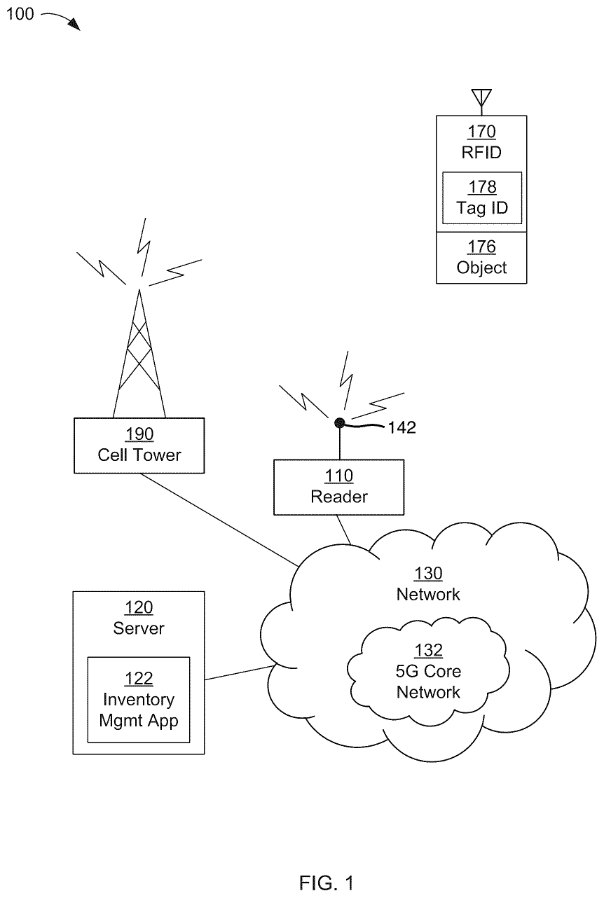

Turning now to FIG. 1, a block diagram of a communication system 100 is shown, in accordance with various examples. The system 100 includes a reader 110 and a network server 120. These elements of the system 100 communicate wired or wirelessly via a network 130. The network 130 may be one or more public networks, one or more private networks, or a combination thereof. The network 130 may comprise or be coupled to a 5G core network 132 or, in other embodiments, a 4G or 4G Long Term Evolution (LTE) network. The system further includes a RFID tag 170. The reader 110 communicates with the RFID tag 170 via RF signals. The RFID tag 170 includes memory (not shown) storing at least a tag ID 178. The RFID tag 170 may be attached to an object 176 such as a product, container, pallet, vehicle, or other asset, a person (such as via a wearable device), or the like. While one RFID tag 170 is shown, many RFID tags 170 may be present in the system 100, each having their own respective tag ID and attached to different objects. The RFID tag 170 may receive RF energy from and exchange RF signals with the reader 110.

The reader 110 may communicate with the RFID tag 170 via an antenna 142. For example, the RFID tag 170 may receive RF energy from and exchange RF signals with the reader 110, at least partially via the antenna 142. In some examples, the antenna 142 may operate in the licensed spectrum overlapping the ISM band, as described above herein. Because the antenna 142 operates in the licensed spectrum, the antenna 142 may have a greater gain than other antennas (not shown) that operate in the ISM band but not in the overlap with the licensed spectrum. For example, other antennas (not shown) that operate in the ISM band but not in the overlap with the licensed spectrum may have a gain of about 2-3 dB relative to isotropic (dBi). Conversely, the antenna 142 may have a gain of greater than 2-3 dBi, such as a gain of about 13 dBi. As described above, for approximately every 6 dB increase in power of a signal transmitted by the antenna 142, a communication range (e.g., a detection range or reading range) of the reader 110 may double. Thus, the reader 110 operating in the licensed spectrum with the antenna 142 having the increased gain may have a communication range that is approximately 2.5-3× a communication range of a reader (not shown) in a same physical location but not operating in the licensed spectrum and communicating subject to restrictions of unlicensed frequency spectrum.

The reader 110 may receive data stored in the RFID tag 170 and send such information via the network 130 or a cell tower 190, to an application or network function (such as inventory management application 122) on the network server 120. For example, in a warehouse or retail establishment, the reader 110 may be located in a generally centralized location. One or more RFID tags 170 may be located in the warehouse or the retail establishment and receive RF energy from the reader 110 and exchange RF signals with the reader 110. The reader 110 may obtain sensor data and/or tag IDs from the one or more RFID tags 170. The reader 110 may send this information via the network 130 to an application or network function (such as inventory management application 122) on the network server 120.

In some examples, the reader 110 may be limited by restrictions imposed in the unlicensed spectrum while also having functionality that increases the usefulness of the reader 110 in the unlicensed spectrum. However, these restrictions may be inapplicable for the reader 110 when used in the licensed spectrum and the functionality that increases the usefulness of the reader 110 in the unlicensed spectrum may in fact hinder operation in the licensed spectrum, as described herein. Accordingly, in some examples, the reader 110, owing at least to its design for use in unlicensed spectrum, may be specially and specifically configured for operation in the licensed spectrum. The configuration may be performed via software, firmware, or both.

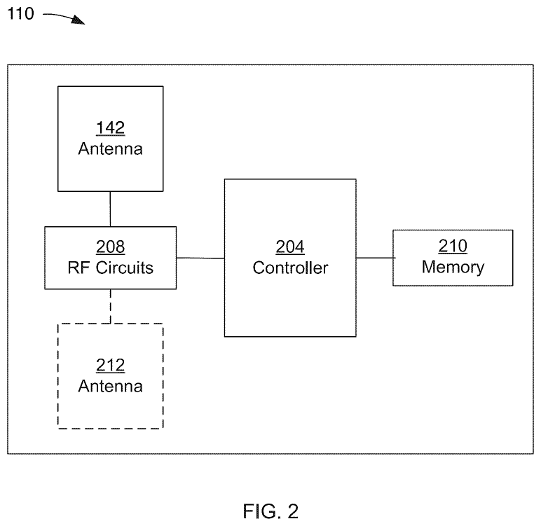

FIG. 2 is a block diagram of a reader 110, in accordance with various examples. The reader 110 includes a controller 204, RF circuits 208, and a memory 210. In some examples, the reader 110 also includes the antenna 142. In other examples, the reader 110 does not include the antenna 142, but rather couples to the antenna 142.

The RF circuits 208 are configured to convert RF energy from the antenna 142 in one or more predetermined RF bands of the licensed spectrum to a signal comprising encoded information, which is sent to the controller 204. The RF circuits 208 also operate in the opposite direction to convert encoded information received from the controller 204 into RF signals in the one or more predetermined RF bands for transmission via the antenna 142.

Received information may include data and/or sender ID. The controller 204 may store the data and/or sender ID, as well as an association between the two in the memory 210. The controller 204 may include (or be coupled to) a clock circuit (not shown) and store a timestamp with the data, ID, and/or association.

In some embodiments, the reader 110 also includes a second antenna 212. In such embodiments, the reader 110 may be configured to communicate with external devices other than the RFID tag(s) 170 in a plurality of RF bands for which physical properties of the antenna 212 make it more efficient or more sensitive than the antenna 142. For example, the antenna 212 may be suitable for 5G communication with the network 130. In such embodiments, the RF circuits 208 may include circuits configured for both the RF band(s) of the antenna 142 and the RF band(s) of the antenna 212.

The controller 204 may be configured to communicate via either or both of the antenna 142 or the antenna 212 using one or more communication protocols. The controller 204 may communicate with the RFID tag(s) 170 using one or more of International Organization for Standardization (ISO) standard ISO11784, joint ISO and International Electrotechnical Commission (IEC) standard ISO/IEC 18000, and/or Electronic Product Code (EPC) standard EPC Gen2. The controller 204 may communicate with the network server 120 using at least one or more of Zigbee, WiFi, and/or Bluetooth RF bands, 4G, 4G LTE, or 5G protocols, or the like.

In some examples, the RF circuits 208 may include configurations rendering the reader 110 suitable for operation in unlicensed spectrum, such as a portion of the ISM band in a first geographic region. That portion of the ISM band may overlap with licensed spectrum in a second geographic region having an application environment in which the reader 110 including the RF circuits 208 is implemented. As such, left with their base or default configurations, the RF circuits may include configurations which unnecessarily restrict operation of the reader 110 in the second geographic region, or actively hinder operation of the reader 110 in the licensed spectrum, as described herein.

For example, to satisfy transmission power restrictions in the first geographic region, the RF circuits 208 may be configured to limit a signal strength or power provided to an antenna, such as the antenna 142. As described above herein, the licensed spectrum may not have such transmission power restrictions, or the transmission power restrictions may be substantially higher so as to render the restrictions outside the scope of concern when implementing the reader 110 in the second geographic region. As such, the signal strength limitations of the RF circuits 208 may unnecessarily restrict operation of the reader 110 in the second geographic region. Similarly, to increase usefulness of the reader 110 in the first geographic region, the RF circuits 208 may be configured to perform other operations, such as frequency hopping. However, when operating at the higher transmission power in the licensed spectrum, the other operations may in fact hinder operation, such as by causing a transmission frequency of the reader 110 to shift outside of the overlap between the licensed spectrum and the unlicensed spectrum. This could cause the reader 110 to be unable to communicate with the RF tag(s) 170 and/or cause the reader 110 to be in violation of restrictions placed on transmission power in the unlicensed spectrum.

To render the RF circuits 208, and therefore reader 110, suitable for implementation in the second geographic region operating in the licensed spectrum, the RF circuits 208 (and/or the controller 204) may be configured to remove at least some unnecessary restrictions that are imposed for operation in the unlicensed spectrum of the first geographic region. Similarly, the RF circuits 208 may be configured to impose at least some restrictions for operation in the second geographic region that are not imposed for operation in the unlicensed spectrum of the first geographic region. In some examples, imposing the restrictions includes disabling functionality of the reader 110 that is useful in operating in the unlicensed spectrum, such as frequency hopping. In other examples, imposing the restrictions includes modifying functionality of the reader 110 that is useful in operating in the unlicensed spectrum, such as frequency hopping (e.g., limiting to which frequency bands frequency hopping may occur to limit the frequency hopping to the overlap between the licensed and unlicensed spectrum). In some examples, imposing the restrictions also includes disabling access of the reader 110 to certain frequency bands, such as frequency bands in the second geographic region in which transmission is prohibited or restricted. Still further, imposing the restrictions may include assigning a particular frequency band to the reader 110, such as a particular frequency band existing in the overlap between the licensed and unlicensed spectrum.

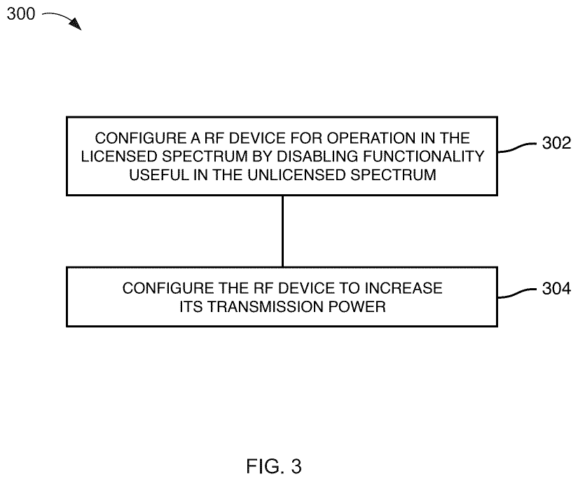

FIG. 3 is a flowchart of a method 300, in accordance with various examples. In some examples, the method 300 is performed to implement an RF device optimized for operating in unlicensed spectrum in a first geographic region instead in licensed spectrum of a second geographic region. For example, the method 300 may be performed to render the RF device suitable for implementation in the second geographic region in a frequency band or range of overlap between the licensed spectrum and the unlicensed spectrum. In some examples, the RF device is the reader 110, as described above herein.

At operation 302, the RF device is configured for operation in the licensed spectrum by disabling functionality useful in the unlicensed spectrum. In some examples, the functionality includes frequency hopping. Disabling the functionality may prevent, or mitigate the chances of, a transmission frequency of the RF device to shift outside of the overlap between the licensed spectrum and the unlicensed spectrum. As such, this may prevent the RF device from becoming incapable of communicating with other intended devices and/or causing the RF device to be in violation of restrictions placed on transmission power in the unlicensed spectrum. In some examples, the configuration is performed via firmware, software, or both.

At operation 304, the RF device is configured to increase its transmission power. In some examples, configuring the RF device to increase its transmission power includes coupling the RF device with an antenna having a gain greater than permissible in the unlicensed spectrum. For example, the antenna may be the antenna 142, as described above herein. In other examples, configuring the RF device to increase its transmission power includes modifying operation of the RF device to increase a signal strength or signal power for a signal that the RF device provides to the antenna for transmission. Increasing the signal strength or signal power may include increasing a gain of amplifiers or other circuitry components of the RF device. In some examples, the configuration is performed via firmware, software, or both. In some implementations of the RF device, both configurations are performed so as to increase the signal strength of the signal provided to the antenna for transmission, as well as increasing the gain of the antenna.

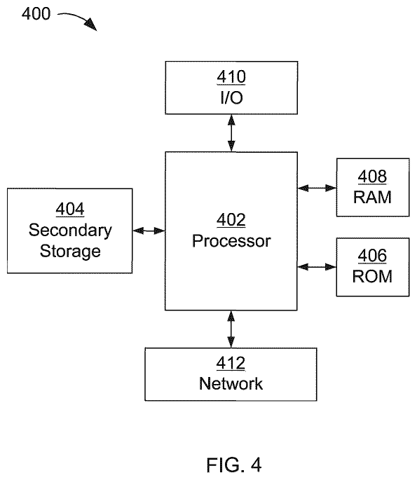

FIG. 4 is a block diagram of a hardware architecture of a device 400, in accordance with various examples. The device 400 may be suitable for implementing at least portions of the reader 110 (e.g., in combination with the RF circuits 208, antenna 142, and/or antenna 212), the server 120, and/or the RF tag 170. The device 400 includes a processor 402 (which may be referred to as a central processor unit (CPU)) that is in communication with memory devices including one or more of secondary storage 404, ROM 406, and/or RAM 408. The processor 402 may also be in communication with input/output (I/O) devices 410, and network connectivity devices 412 (for example, the RF circuits 208). The processor 402 may be implemented as one or more CPU chips.

In an example, the controller 204 comprises any or all of the processor 402, secondary storage 404, ROM 406, RAM 408, and/or I/O devices 410. The memory 210 comprises any or all of the secondary storage 404 and/or RAM 408.

By programming and/or loading executable instructions onto the device 400, at least one of the CPU 402, the RAM 408, and the ROM 406 are changed, transforming the device 400 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the device 400 is turned on or booted, the CPU 402 may execute a computer program or application. For example, the CPU 402 may execute software or firmware stored in the ROM 406 or stored in the RAM 408. In some examples, that software or firmware includes modifications or particular programming to configure the device 400 for operation in the second geographic regions overlap between licensed spectrum of the second geographic region and unlicensed spectrum of the first geographic region. In some cases, on boot and/or when the application is initiated, the CPU 402 may copy the application or portions of the application from the secondary storage 404 to the RAM 408 or to memory space within the CPU 402 itself, and the CPU 402 may then execute instructions that the application is comprised of. During execution, an application may load instructions into the CPU 402, for example load some of the instructions of the application into a cache of the CPU 402. In some contexts, an application that is executed may be said to configure the CPU 402 to do something, e.g., to configure the CPU 402 to perform the function or functions promoted by the subject application. When the CPU 402 is configured in this way by the application, the CPU 402 becomes a specific purpose computer or a specific purpose machine.

The secondary storage 404 is used for non-volatile storage of data and as an over-flow data storage device if RAM 408 is not large enough to hold all working data. Secondary storage 404 may be used to store programs which are loaded into RAM 408 when such programs are selected for execution. The ROM 406 is used to store instructions and perhaps data which are read during program execution. ROM 406 is a non-volatile memory device which typically has a small memory capacity relative to the larger memory capacity of secondary storage 404. The RAM 408 is used to store volatile data and perhaps to store instructions. Access to both ROM 406 and RAM 408 may be faster than to secondary storage 404. The secondary storage 404, the RAM 408, and/or the ROM 406 may be referred to in some contexts as computer readable storage media and/or non-transitory computer readable media.

The processor 402 executes instructions, codes, computer programs, scripts which it accesses from the secondary storage 404, the ROM 406, or the RAM 408. While only one processor 402 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 404, the ROM 406, and/or the RAM 408 may be referred to in some contexts as non-transitory instructions and/or non-transitory information.

In some contexts, the secondary storage 404, the ROM 406, and the RAM 408 may be referred to as a non-transitory computer readable medium or a computer readable storage media. A dynamic RAM embodiment of the RAM 408, likewise, may be referred to as a non-transitory computer readable medium in that while the dynamic RAM receives electrical power and is operated in accordance with its design, for example during a period of time during which the device 400 is powered up and operational, the dynamic RAM stores information that is written to it. Similarly, the processor 402 may comprise an internal RAM, an internal ROM, a cache memory, and/or other internal non- transitory storage blocks, sections, or components that may be referred to in some contexts as non-transitory computer readable media or computer readable storage media.

While several examples have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various examples as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A communication system for inventory management via wireless monitoring, comprising:
radio frequency identification (RFID) tags configured to operate in a frequency band that is unlicensed in a first geographic region and is licensed in a second geographic region;
a RFID reader designed according to operational parameters of the first geographic region, the RFID reader configured to read, in the second geographic region, data from the RFID tags via radio frequency (RF) signal transmissions in the frequency band, wherein the RFID reader performs the RF signal transmissions at a power level that exceeds the operational parameters of the first geographic region, and wherein the RFID reader comprises:
a RF circuit, the RF circuit programmed according to the operational parameters;
an antenna communicatively coupled to the RF circuit and configured to perform the RF signal transmissions in the frequency band; and
a controller coupled to the RF circuit, the controller configured to program the RF circuit with second operational parameters, the second operational parameters configured to cause the RFID reader to operate outside of requirements for operation in the unlicensed frequency spectrum in the first geographic region as defined by the operational parameters.

2. The communication system of claim 1, wherein the antenna has a gain that exceeds a gain limit of the operational parameters of the first geographic region.

3. The communication system of claim 2, wherein the antenna has a gain of at least 13 decibels relative to isotropic (dBi).

4. The communication system of claim 1, wherein programming the RF circuit with the second operational parameters causes the RF circuit to be configured to provide a signal to the antenna for transmission, the signal having a power level that exceeds the requirements for operation in the unlicensed frequency spectrum in the first geographic region.

5. The communication system of claim 1, wherein programming the RF circuit with the second operational parameters disables frequency hopping by the RFID reader.

6. The communication system of claim 1, wherein programming the RF circuit with the second operational parameters restricts the RF circuit to operation within the frequency band, the frequency band existing in an overlap between the unlicensed frequency spectrum in the first geographic region and the licensed frequency spectrum in the second geographic region.

7. The communication system of claim 1, further comprising an application server that comprises an inventory management application, wherein the RFID reader is configured to transmit the data from the RFID tags to the application server.

8. The communication system of claim 1, wherein the RFID tags and the RFID reader are located in a warehouse or a retail establishment.

9. An apparatus configured at a first time with first system parameters according to requirements for operation in unlicensed frequency spectrum in a first geographic region, comprising:
a radio frequency (RF) circuit, the RF circuit programmed according to the first system parameters;
an antenna communicatively coupled to the RF circuit and configured to perform RF transmissions in a band of licensed frequency spectrum in a second geographic region different from the first geographic region, the band of licensed frequency spectrum overlapping with the unlicensed frequency spectrum; and
a controller coupled to the RF circuit, the controller configured to:
program the RF circuit with second system parameters, the second system parameters configured to cause the apparatus to operate outside of the requirements for operation in the unlicensed frequency spectrum in the first geographic region.

10. The apparatus of claim 9, wherein programming the RF circuit with the second system parameters causes the RF circuit to be configured to provide a signal to the antenna for transmission, the signal having a power level that exceeds the requirements for operation in the unlicensed frequency spectrum in the first geographic region.

11. The apparatus of claim 9, wherein programming the RF circuit with the second system parameters disables frequency hopping by the apparatus.

12. The apparatus of claim 9, wherein programming the RF circuit with the second system parameters assigns a constrained frequency band to the RF circuit, the frequency band existing in an overlap between the unlicensed frequency spectrum in the first geographic region and the licensed frequency spectrum in the second geographic region.

13. The apparatus of claim 9, wherein the apparatus is a radio frequency identification (RFID) reader configured to read data from RFID tags, wherein programming the RF circuit with the second system parameters increases a first distance at which the apparatus is capable of reading the RFID tags in comparison to a second distance at which the apparatus is capable of reading the RFID tags while configured with the first system parameters.

14. The apparatus of claim 9, wherein the antenna is a high-gain antenna having a gain that exceeds the requirements for operation in the unlicensed frequency spectrum in the first geographic region.

15. An apparatus having system parameters configured according to requirements for operation in unlicensed frequency spectrum in a first geographic region, comprising:
a controller;
a radio frequency (RF) circuit communicatively coupled to the controller; and
an antenna communicatively coupled to the RF circuit and configured to perform RF transmissions in a band of licensed frequency spectrum in a second geographic region different from the first geographic region, the band of licensed frequency spectrum overlapping with the unlicensed frequency spectrum, wherein the antenna has a gain that exceeds a gain limit of the requirements for operation in the unlicensed frequency spectrum in the first geographic region.

16. The apparatus of claim 15, wherein the apparatus is a radio frequency identification (RFID) reader, and wherein the antenna is configured to communicate with at least one RFID tag in the second geographic region, the RFID tag capable of operating in both the licensed frequency spectrum and the unlicensed frequency spectrum.

17. The apparatus of claim 15, wherein the antenna has a gain of at least 13 decibels relative to isotropic (dBi).

18. The apparatus of claim 15, wherein the controller is configured to program the RF circuit to disable at least some features enabled by the system parameters.

19. The apparatus of claim 18, wherein the controller programs the RF circuit to disable frequency hopping by the apparatus.

20. The apparatus of claim 15, wherein the controller is configured to program the RF circuit to provide a signal to the antenna having a signal strength that exceeds a signal strength specified in the system parameters.
